(19) United States
(12) Patent Application Publication
(10) Pub. No.: US 2014/0349175 A1
(43) Pub. Date: Nov. 27, 2014

(54) BATTERY MODULE

(71) Applicants: Yasuo Iwata, Kiyosu-shi (JP); Yasunori Uchida, Kiyosu-shi (JP); Tadanobu Ota, Kiyosu-shi (JP); Shinichi Takeda, Kiyosu-shi (JP)

(72) Inventors: Yasuo Iwata, Kiyosu-shi (JP); Yasunori Uchida, Kiyosu-shi (JP); Tadanobu Ota, Kiyosu-shi (JP); Shinichi Takeda, Kiyosu-shi (JP)

(73) Assignee: TOYODA GOSEI CO., LTD., Kiyosu-shi, Aichi-ken (JP)

(21) Appl. No.: 14/371,117

(22) PCT Filed: Sep. 13, 2012
(86) PCT No.: PCT/JP2012/005839

§ 371 Date: Jul. 8, 2014

(30) Foreign Application Priority Data
Jan. 26, 2012 (JP) 2012-13688

(51) Int. Cl. H01M 2/30

(52) U.S. Cl. CPC H01M 2/30
USPC 429/179

(57) ABSTRACT

A battery module comprises a battery element and a storage unit configured to contain the battery element therein. The storage unit comprises an electrically conductive positive electrode-side plate and an electrically conductive negative electrode-side plate. The positive electrode-side plate and the negative electrode-side plate define a storage space to contain the battery element therein. The storage unit has a joint end provided on the periphery of the storage space and formed by joining an outer peripheral area of the positive electrode-side plate with an outer peripheral areal of the negative electrode-side plate across an insulating sheet placed between the two outer peripheral areas. The joint end comprises: a wind part formed by stacking and winding the two outer peripheral areas to be pressure-bonded to and joined with each other; and an outer peripheral frame body formed by insert molding using an insulating resin to surround the wind part.

### TECHNICAL FIELD

The present invention relates to a battery module configured to contain a battery element therein.

### BACKGROUND ART

A known technique with regard to the battery module uses a battery casing to seal a battery element (Patent Literature 1). The battery casing has a case body member to contain the battery element therein and a cover member to cover over an opening of the case body member. The peripheries of the case body member and the cover member are caulked to prevent leakage of an electrolytic solution.

In the battery module, especially when the case body member used is a rectangular thin plate member, the case body member is likely to be deformed at a straight portion of the rectangle and cause a decrease in sealing property. In order to solve such a problem, the technique disclosed in Patent Literature 1 forms a notch (rib) in the straight portion to enhance the mechanical strength. The advantageous effect of the notch, however, significantly differs by the location and the shape of the notch. It is accordingly difficult to achieve the excellent sealing property by the simple structure.

### CITATION LIST

### Patent Literature

PTL 1: JP 2002-124219A

### SUMMARY OF INVENTION

### Technical Problem

By taking into account the above problem, one object of the invention is to provide a battery module having excellent sealing property provided by a simple structure.

### Solution To Problem

in order to achieve at least part of the above object, the invention may be implemented by the following aspects.

[Aspect 1] According to Aspect 1, there is provided a battery module comprising: a battery element; and a storage unit configured to contain the battery element therein. The storage unit comprises an electrically conductive positive electrode-side plate and an electrically conductive negative electrode-side plate, wherein the positive electrode-side plate and the negative electrode-side plate define a storage space to contain the battery element therein. The storage unit has a joint end provided on periphery of the storage space and formed by joining an outer peripheral area of the positive electrode-side plate with an outer peripheral area of the negative electrode-side plate across an insulating sheet placed between the two outer peripheral areas. The joint end comprises: a wind part formed by stacking and winding the two outer peripheral areas to be pressure-bonded to and joined with each other; and an outer peripheral frame body formed by insert molding using an insulating resin to surround the wind part,

In the battery module according to Aspect 1, the battery element is contained in the storage unit, and electricity generated by the battery element is taken outside via the storage unit. The storage unit has the battery element contained in the storage space defined by the positive electrode-side plate and the negative electrode-side plate. The storage unit is sealed with the joint end provided on the periphery of the storage space and formed by the outer peripheral areas of the positive electrode-side plate and the negative electrode-side plate. The joint end includes the wind part and the outer peripheral frame body. The wind part is formed by stacking and winding the outer peripheral areas of the positive electrode-side plate and the negative electrode-side, plate to be pressure-bonded to and joined with each other. Additionally, the wind part is surrounded by the outer peripheral frame body by insert molding. The outer peripheral frame body covers over the wind part such as to reinforce and protect the wind part. This structure applies large force to prevent the wind part. from being opened and ensures the high sealing property.

[Aspect 2] According to Aspect 2, the joint end may have an adhesive layer in a contact area where the wind part is in contact with the outer peripheral frame body. In this structure, the presence of the adhesive layer in the joint end applies the stronger force to prevent the wind part from being opened.

[Aspects 3 and 4] According to Aspect 3, the wind part may have an end bent to be extended in a direction d1 from the outer peripheral areas, where d1 represents a joint direction of the positive electrode-side plate and the negative electrode-side plate. According to Aspect 4, the wind part may have an end bent to be extended in a direction d2 from the outer peripheral areas of the positive electrode-side plate and the negative electrode-side plate, where d1 represents a joint direction of the positive electrode-side plate and the negative electrode-side plate and d2 represents a direction orthogonal to the direction d1. In these structures, the outer peripheral frame body does not apply a force in the opening direction to the end of the wind part even in the event of an increase in internal pressure of the storage unit of the battery module and has excellent sealing property.

### BRIEF DESCRIPTION OF DRAWINGS

FIG. 1 is a perspective view illustrating the appearance of a battery module according to one embodiment of the invention;

FIG. 2 is a sectional view of the battery module of FIG. 1 taken on a line 2-2;

FIG. 3 is a sectional view of the battery module of FIG. 1 taken on a line 3-3;

FIG. 4 is a perspective view illustrating the state prior to assembly of the battery module;

FIG. 5 is a sectional view illustrating an upper portion of the battery module of FIG. 2;

FIG. 6 is a sectional view illustrating a lower portion of the battery module of FIG. 2;

FIG. 7 is a chart showing an assembly process of the battery module;

FIG. 8 is a diagram illustrating the assembly process of the battery module;

FIG. 9 is a diagram illustrating the assembly process of the battery module, subsequent to FIG. 8;

FIG. 10 is a diagram illustrating the assembly process of the battery module, subsequent to FIG. 9;

FIG. 11 is a diagram illustrating the assembly process of the battery module, subsequent to FIG. 10;

FIG. 12 is diagrams illustrating a winding process;

FIG. 13 is a diagram illustrating an injection process of the battery module;

FIG. 14 is a diagram illustrating the functions of the battery module; and

FIG. 15 is a sectional view illustrating one end portion of a battery module according to another embodiment.

### DESCRIPTION OF EMBODIMENTS

### (1) Structure of Battery Module 10

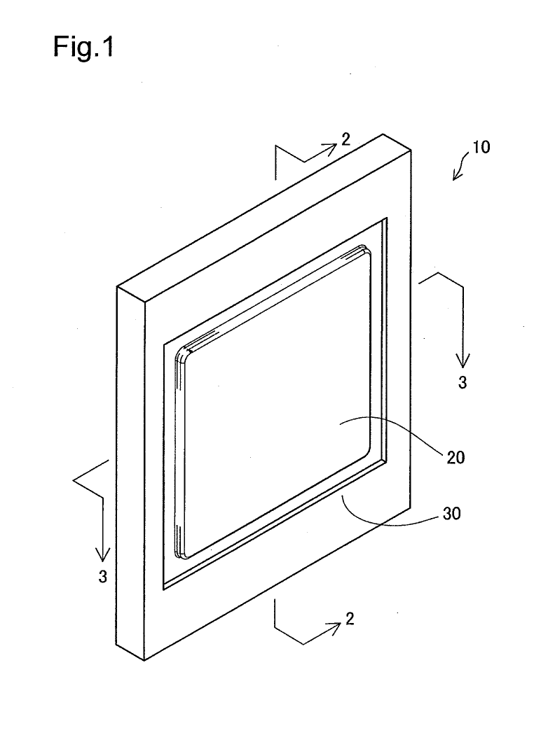

The following describes embodiments of the invention with reference to drawings. FIG. 1 is a perspective view illustrating the appearance of a battery module 10 according to one embodiment of the invention. The battery module 10 includes a battery element 20 and a storage unit 30.

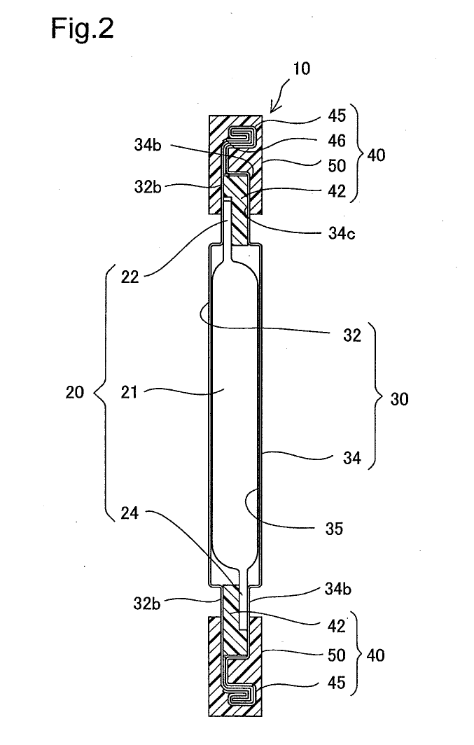

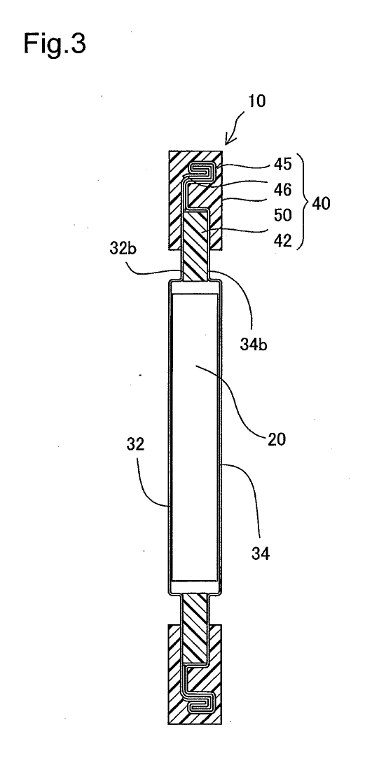

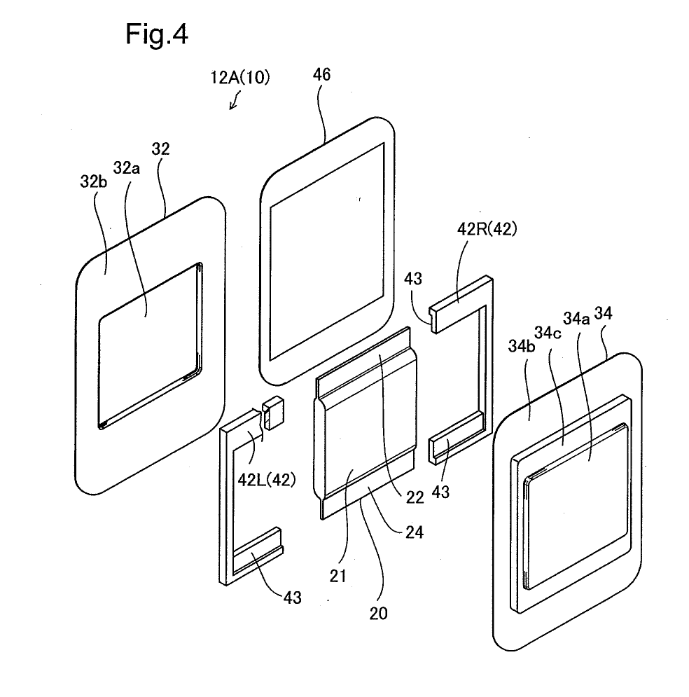

FIG. 2 is a sectional view of the battery module 10 of FIG. 1 taken on a line 2-2. FIG. 3 is a sectional view of the battery module 10 taken on a line 3-3. FIG. 4 is a perspective view illustrating the state prior to assembly of the battery module 10. With referring to FIG. 2, the battery element 20 is a battery unit that is charged and discharged, for example, as a lithium secondary battery and is produced by winding metal thin films for a positive electrode and a negative electrode across an electrolyte. The battery element 20 includes a flat and rectangular battery element main body 21, a positive electrode collector foil 22 protruded from one end of the battery element main body 21 and a negative electrode collector foil 24 protruded from the other end. The positive electrode collector foil 22 is made of aluminum, and the negative electrode collector foil 24 is made of copper.

The storage unit 30 includes a positive electrode-side plate 32 made from, for example, a press molded product of an aluminum plate and a negative electrode-side plate 34 made of copper. The positive electrode-side plate 32 and the negative electrode-side plate 34 respectively have recesses on their center areas. A storage space 35 is formed by mating and joining these recesses with each other to contain the battery element 20 therein.

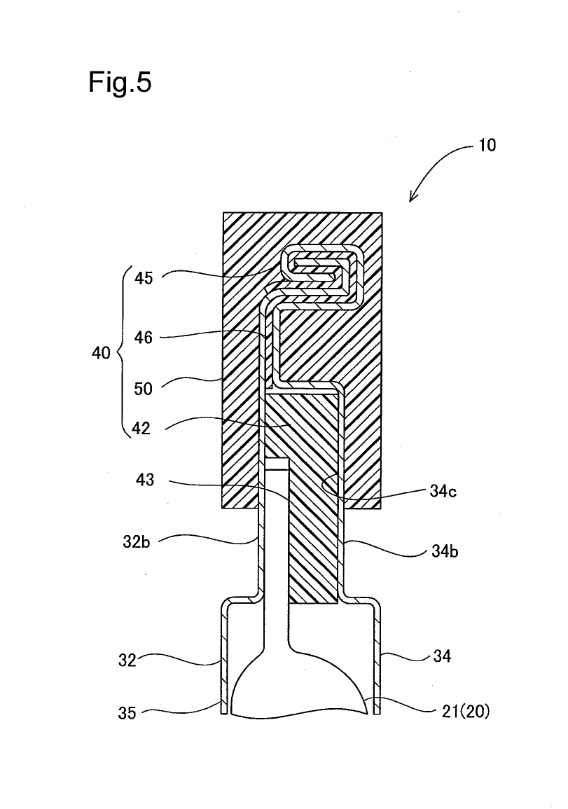

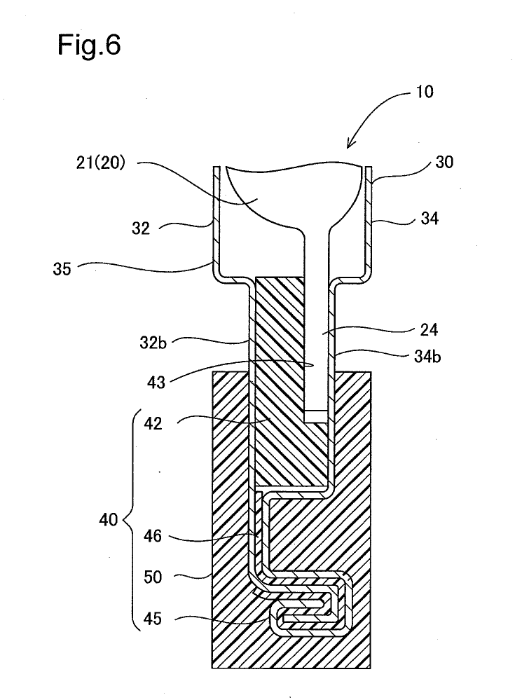

FIG. 5 is a sectional view illustrating an upper portion of the battery module 10 of FIG. 2. FIG. 6 is a sectional view illustrating a lower portion of the battery module 10 of FIG. 2. With referring to FIG. 5, the storage unit 30 has a joint end 40 on the periphery of the storage space 35. The joint end 40 is provided to he extended over an outer peripheral area 32b of the positive electrode-side plate 32 and an outer peripheral area 34b of the negative electrode-side plate 34. The positive electrode collector foil 22 is electrically connected with the outer peripheral area 32b in the state that a middle frame body 42 is placed between the outer peripheral area 32b and the outer peripheral area 34b. Like the positive electrode collector foil 22, the negative electrode collector foil 24 is electrically connected with the outer peripheral area 34h as shown in FIG. 6. As shown in FIG. 4, a storage recess 34c is formed in the outer peripheral area 34b of the negative electrode-side plate 34, and the middle frame body 42 is contained in the storage recess 34c. The middle frame body 42 is an insulating resin molded product, which is a two-section product split vertically into a left-side frame section 421, and a right-side frame section 42R. These two frame sections are mated and joined with each other to form a frame body that surrounds the battery element 20. The middle frame body 42 has collector foil holding parts 43 with steps. The steps of the collector foil holding parts 43 are provided to press the positive electrode collector foil 22 against the outer peripheral area 32b (FIG. 5), while pressing the negative electrode collector foil 24 against the outer peripheral area 34b (FIG. 6).

As shown in FIGS. 5 and 6 the joint end 40 includes a wind part 45 provided to join the respective ends of the positive electrode-side plate 32 and the negative electrode-side plate 34 with each other, and an outer peripheral frame boy 50 resin-molded to mold the wind part 45. The wind part 45 has a double-winding structure formed by stacking and winding the outer peripheral. area 32b and the outer peripheral area 34b across an insulating sheet 46 placed between the outer peripheral areas 32b and 34b to be pressure-bonded to and joined with each other. The double-winding structure is formed by utilizing the general-purpose can manufacturing method described later. The outer peripheral frame body 50 is formed by insert molding using an insulating resin with the wind part 45 as the insert member.

### (2) Manufacturing Method of Battery Module 10

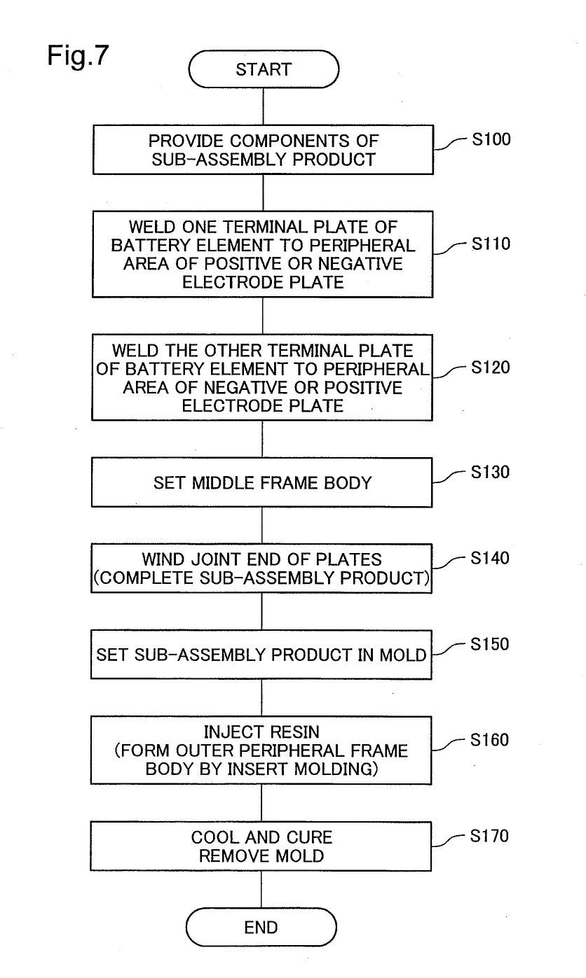

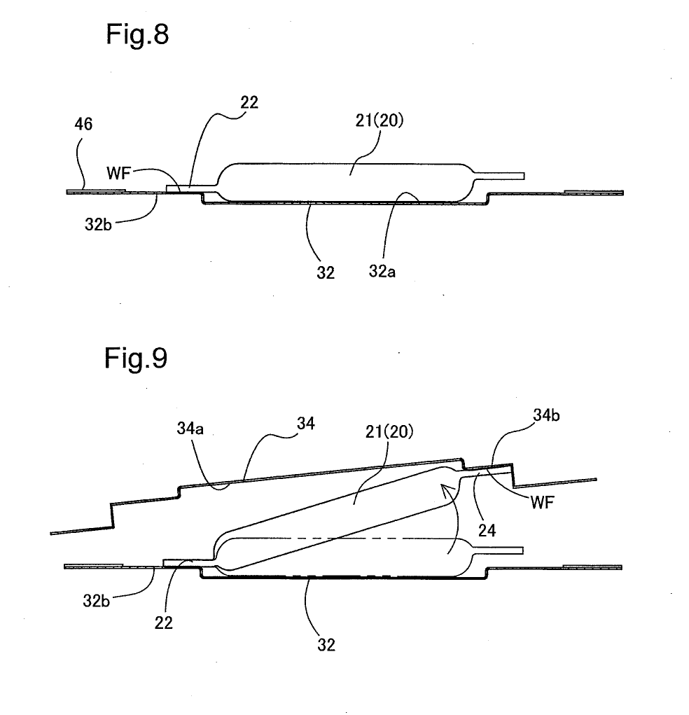

The following describes a manufacturing method of the above battery module 10. FIG. 7 is a chart showing an assembly process of the battery module 10. At step S100, the process provides the respective components constituting the battery module 10, i.e., the battery element 20, the positive electrode-side plate 32, the negative electrode-side plate 34, the middle frame body 42 and the insulating sheet 46. At step S110, as shown in FIG. 8, the process subsequently places the insulating sheet 46 on the outer peripheral area 32b of the positive electrode-side plate 32, places the battery element main body 21 of the battery element 20 in the recess of a positive electrode plate main body 32a of the positive electrode-side plate 32, and welds (for example, spot-welds) the positive electrode collector foil 22 to a welding region WF of the outer peripheral area 32h with a welding electrode (not shown). This causes the positive electrode-side plate 32 to be integrated with the battery element 20 in the outer peripheral area 32b.

At step S120, as shown. in FIG. 9, the process subsequently tilts the battery element 20 placed in the recess of the positive electrode-side plate 32 such that the negative electrode collector foil 24-side of the battery element 20 is away from the positive electrode-side plate 32, sets the negative electrode-side plate 34 such that its recess covers over the battery element main boy 21 of the battery element 20, and welds the negative electrode collector foil 24 to a welding region WF of the outer peripheral area 34b with a welding electrode. This causes the negative electrode-side plate 34 to be integrated with the battery element 20 and causes the battery element main body 21 to he contained in the storage space 35 (FIG. 2).

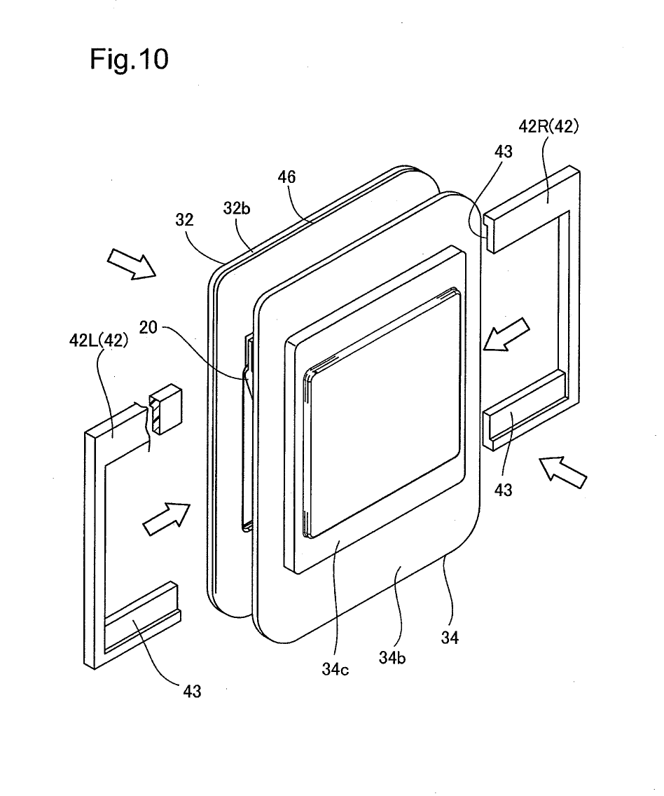

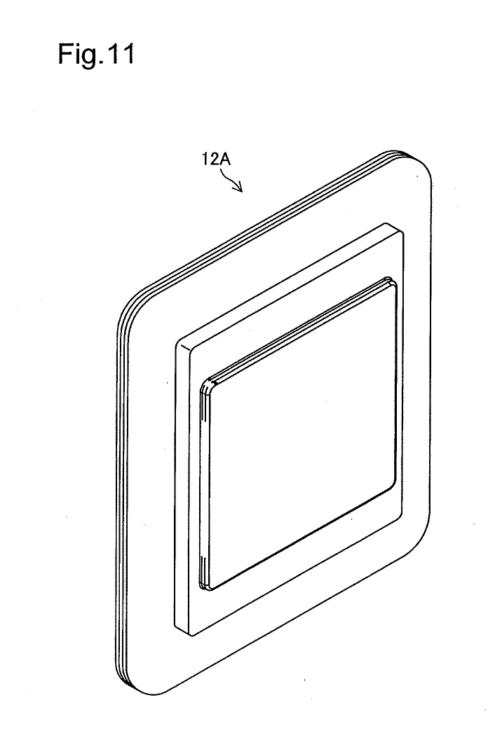

At subsequent step S130, as shown in FIG. 10, the process inserts the left-side frame section 42L and the right-side frame section 42R constituting the middle frame body 42 between the positive electrode collector foil 22 and the outer peripheral area 32b and between the negative electrode collector foil 24 (FIG. 6) and the outer peripheral area 34b, adjusts the position of the middle frame body 42 to the storage recess 34c of the negative electrode-side plate 34, and joins the left-side frame section 421, and the right-side frame section 42R with each other at their opening end surfaces, In this state, the middle frame body 42 is pressed by the positive electrode-side plate 32 and the negative electrode-side plate 34. This provides a sub-assembly product 12A in which the battery element 20 is contained by the positive electrode-side plate 32 and the negative electrode-side plate 34 and the middle frame body 42 and the insulating sheet 46 are further assembled (FIG. 11).

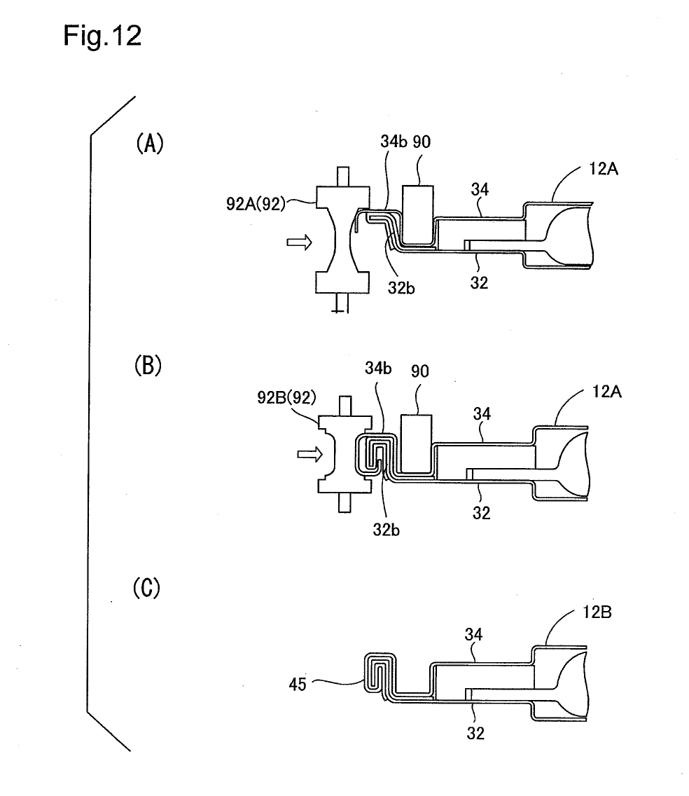

At step S140, the process subsequently performs a winding process. FIG. 12 is diagrams illustrating the winding process. The winding process employs the general-purpose double-winding technique to cover a can. More specifically, as shown in FIG. 12, the winding process sets the outer peripheral areas 32b and 34b of the subassembly product 12A in a seaming chuck 90 and rotates the outer peripheral areas 32b and 34h while pressing the outer peripheral areas 32b and 34b against the seaming chuck 90 by a seaming roll 92 to implement bending and forming along the entire circumference of the sub-assembly product 12A. As shown in FIGS. 12(A) and 12(B), the outer peripheral areas 32b and 34b are sequentially bent by stepwise folding operations using the seaming chuck 90 and the seaming rolls 92A and 92B. This provides a subassembly product 12B with the wind part 45 as shown in FIG. 12(C).

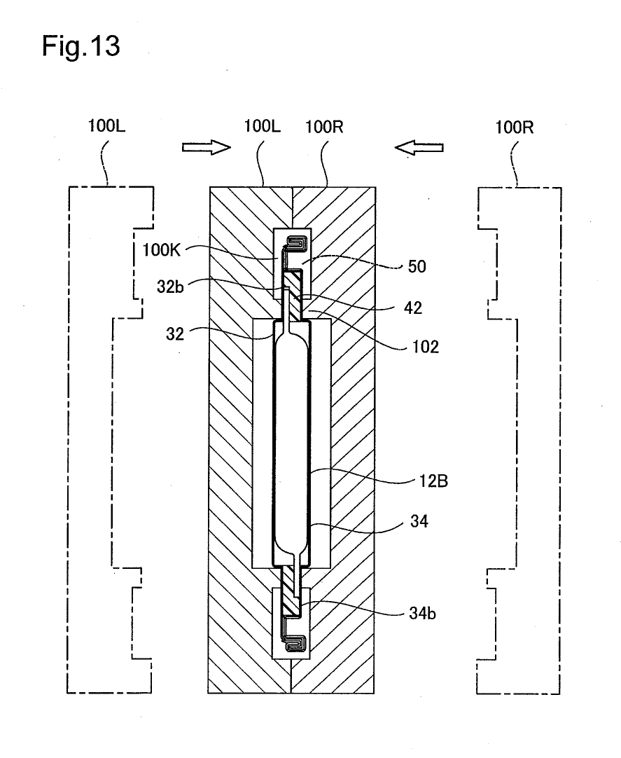

At step S150, the process subsequently sets the sub-assembly product 12B in a mold. FIG. 13 is a diagram illustrating the subassembly product 12 with the mold. As illustrated, the mold is a split mold consisting of a left mold part 100L and a right mold part 100R. The left mold part 100L and the right mold part 100R are joined together to form a cavity 100K. The cavity 100K surrounds the outer periphery of the sub-assembly product 12. The left and the right mold parts have shoulder projections 102 protruded from the mold surfaces toward the cavity 100K to press the outer peripheral area 32b of the positive electrode-side plate 32 and the outer peripheral area 34b of the negative electrode-side plate 34 against the middle frame body 42, so as to hold the sub-assembly product 12. This completes setting the sub-assembly product 12B in the mold. At subsequent step S160, the process injects an insulating resin into the cavity 100K to make the sub-assembly product 12 subject to insert molding. Such insert molding forms the outer peripheral frame body 50 in the cavity 100K. After injection of the resin, the process causes the resin to be cooled and cured and subsequently removes the mold (step S170). This provides the battery module 10 shown in FIG. 1.

### (3) Functions and Advantageous Effects of Embodiment

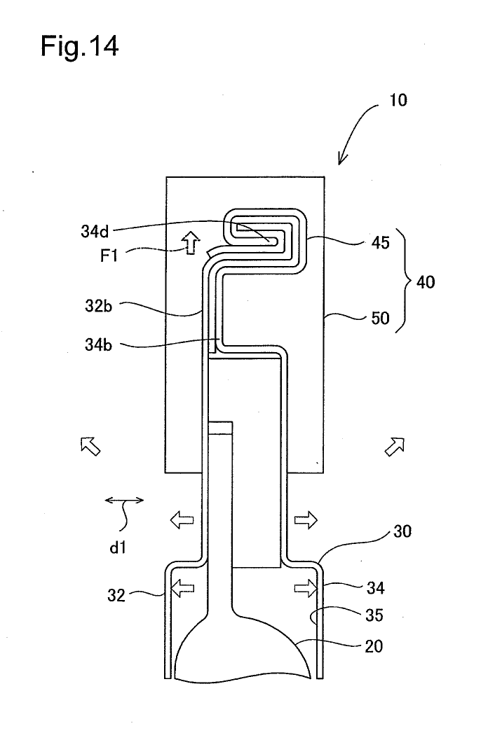

The above structure of the embodiment has the following advantageous effects.
(3)-1, As shown in FIG. 14, the storage unit 30 is sealed by the joint end 40 provided along the periphery of the storage space 35 and formed at the outer peripheral areas 32b and 34b of the positive electrode-side plate 32 and the negative electrode-side plate 34, The joint end 40 seals the storage unit 30 at the wind part 45 of the double-winding structure formed by stacking and winding the outer peripheral areas 32b and 34b of the positive electrode-side plate 32 and the negative electrode-side plate 34 to be press-bonded to and joined with each other. Additionally, in the joint end 40, the wind part 45 is sealed and reinforced to be protected from an external force by the outer peripheral frame body 50 that surrounds the wind part 45 by insert molding. The wind part 45 and the outer peripheral frame body 50 of the joint end 40 apply large force to prevent the respective ends of the positive electrode-side plate 32 and the negative electrode-side plate 34 from being separated from each other even in the event of a significant increase in internal pressure of the storage space 35 of the battery module 10 and ensure the high sealing property,
(3)-2. As shown in FIG. 14, the outer peripheral area 34b at the wind part 45 has its end 34d bent to face in the same direction as a joint direction d1 of the positive electrode-side plate 32 and the negative electrode-side plate 34. Even when an external force is applied in a direction of separating the positive electrode-side plate 32 from the negative electrode-side plate 34 via the outer peripheral frame body 50, the end 34d does not receive a separating force F1. This arrangement accordingly ensures the excellent sealing property.
(3)-3, As shown in FIG. 13, the outer peripheral frame body 50 is formed around the wind part 45 as the insert member by injection molding in the state that the battery element 20 is contained in the storage space 35. This facilitates the production of the outer peripheral frame body 50.

### (4) Other Embodiments

The invention is not limited to the above embodiment, but a diversity of variations and modifications may be made to the embodiment without departing from the scope of the invention. Some examples of possible modification are described below.

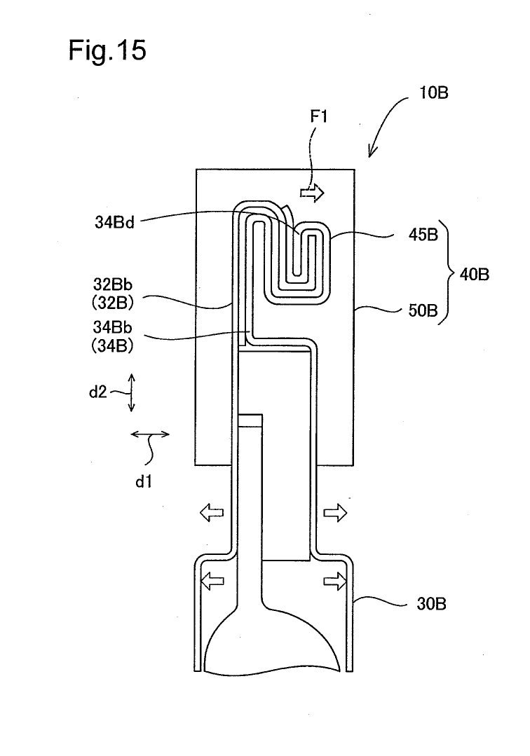

(4)-1. FIG. 15 is a sectional view illustrating an end of a battery module 10B according to another embodiment. This embodiment is characterized by the structure of a wind part 45B of a joint end 40B. More specifically, the wind part 45B has a double-winding structure of outer peripheral areas 32Bb and 34Bb of a positive electrode-side plate 32B and a negative electrode-side plate 34B. An end 34Bd of the wind, part 45B faces outward, where d1 represents the joint direction of the positive electrode-side plate 32B and the negative electrode-side plate 34B and d2 represents a direction orthogonal to the direction d1. An outer peripheral frame body 50B does not apply a force F1 in the opening direction to the end 34Bd of the wind part 45B even with an increase in internal pressure of the storage unit 30B of the battery module 10B and ensures the excellent sealing property.

(4)-2, A joint end of another embodiment is characterized by the structure including an adhesive layer that enhances the adhesive force between a wind part and an outer peripheral frame body by chemical adhesion. This structure is obtained by the following procedure. A polar functional group such as carboxyl group, amino group or hydroxyl group is added to the surface of an outer peripheral area of each of positive electrode-side and negative electrode-side plates. More specifically, an organic substance is activated with a radical produced by plasma generated in a discharged gas, and the activated organic substance is used to add a polar functional group to the surface of the outer peripheral area. The wind part is formed by double winding of the outer peripheral areas. In the process of injection molding the outer peripheral frame body, an adhesive modifier including an adhesive functional group, for example, epoxy group, which interacts with the above polar functional group, is mixed with the insulating resin used to form the outer peripheral frame body. The wind part and the outer peripheral frame body are accordingly bonded to each other by interaction between the polar functional group and the adhesive functional group. This enhances the reliability of sealing by the outer peripheral frame body. According to this embodiment, it is preferable to apply the adhesive layer on the wind part, prior to the step of setting the sub-assembly product in the mold of FIG. 12.

(4)-3. The above embodiment describes the single battery module such as button battery, The invention is, however, not restricted to the single battery module but is also applicable to a battery unit obtained by stacking a plurality of battery modules.

(4)-4. The above embodiment describes the middle frame body 42 structured as the two-section product as shown in FIG. 4. This structure is, however, not restrictive, and the middle frame body may be integrally formed to surround the entire circumference of the battery element. In this modification, the process may exchange the sequence of step S120 and step S130 in FIG. 7 or more specifically set the middle frame body on the battery element and subsequently weld the plates.

### REFERENCE SIGNS LIST

10 Battery module
10B Battery module
12 Sub-assembly product
12A Sub-assembly product
12B Subassembly product
20 Battery element
21 Battery element main body
22 Positive electrode collector foil
24 Negative electrode collector foil
30 Storage unit
30B Storage unit
32b, 34b Outer peripheral areas
32 Positive electrode-side plate
32a Positive electrode plate main body
32Bb, 34Bb Outer peripheral areas
34 Negative electrode-side plate
34c Storage recess
34d End
34Bd End
35 Storage space
40 joint end
40B Joint end
42 Middle frame body
42L Left-side frame section
42R Right-side frame section.
43 Collector foil holding parts
45 Wind part
45B Wind part
46 Insulating sheet
50 Outer peripheral frame body
50B Outer peripheral frame body
90 Seaming chuck
90, 92A, 92B Seaming rolls
100K Cavity
100L Left mold part
100R Right mold part
102 Shoulder projection
WF Welding region

1. A battery module comprising: a battery element; and a storage unit configured to contain the battery element therein, wherein
the storage unit comprises an electrically conductive positive electrode-side plate and an electrically conductive negative electrode-side plate, wherein the positive electrode-side plate and the negative electrode-side plate define a storage space to contain the battery element therein,
the storage unit has a joint end provided on periphery of the storage space and formed by joining an outer peripheral area of the positive electrode-side plate with an outer peripheral area of the negative electrode-side plate across an insulating sheet placed between the two outer peripheral areas, wherein
the joint end comprises: a wind part formed by stacking and winding the two outer peripheral areas to be pressure-bonded to and joined with each other; and an outer peripheral frame body formed by insert molding using an insulating resin to surround the wind part.

2. The battery module according to claim 1,
wherein the joint end has an adhesive layer in a contact area where the wind part is in contact with the outer peripheral frame body.

3. The battery module according to claim 1,
wherein the wind part has an end bent to be extended in a direction d1 from the outer peripheral areas, where d1 represents a joint direction of the positive electrode-side plate and the negative electrode-side plate.

4. The battery module according to claim 1,
wherein the wind part has an end bent to be extended in a direction d2 from the outer peripheral areas of the positive electrode-side plate and the negative electrode-side plate, where d1 represents a joint direction of the positive electrode-side plate and the negative electrode-side plate and d2 represents a direction orthogonal to the direction d1.

5. The battery module according to claim 2,
wherein the wind part has an end bent to be extended in a direction d1 from the outer peripheral areas, where d1 represents a joint direction of the positive electrode-side plate and the negative electrode-side plate.

6. The battery module according to claim 2,
wherein the wind part has an end bent to be extended in a direction d2 from the outer peripheral areas of the positive electrode-side plate and the negative electrode-side plate, where d1 represents a joint direction of the positive electrode-side plate and the negative electrode-side plate and d2 represents a direction orthogonal to the direction d1.
